(19) United States
(12) Patent Application Publication
(10) Pub. No.: US 2010/0088732 A1
(43) Pub. Date: Apr. 8, 2010

(54) METHOD AND APPARATUS FOR USING SERVICE BASED ON OBJECTS FOR IMPLEMENTING DIFFERENT FUNCTIONS OF SERVICE

(75) Inventors: Jung-shin PARK, Suwon-si (KR); Young-soo KANG, Seoul (KR); Kwang-hyuk KIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/572,348

(22) Filed: Oct. 2, 2009

Related U.S. Application Data
(60) Provisional application No. 61/102,138, filed on Oct. 2, 2008.

(30) Foreign Application Priority Data
Nov. 24, 2008 (KR) 10-2008-0117055

(51) Int. Cl. H04N 7/18

(52) U.S. Cl. 725/78

(57) ABSTRACT

Provided are a method and apparatus for generating a plurality of objects for implementing different functions related to a service provided via a home network; and using the service based on the plurality of objects.

### CROSS-REFERENCE TO RELATED PATENT APPLICATION

This application claims the benefit of U.S. Provisional Patent Application No. 61/102,138, filed on Oct. 2, 2008, in the U.S. Patent and Trademark Office, and the benefit of Korean Patent Application No. 10-2008-0117055, filed on Nov. 24, 2008, in the Korean Intellectual Property Office, the disclosures of which are incorporated herein in their entirety by reference.

### BACKGROUND OF THE INVENTION

1. Field of the Invention

Methods and apparatuses consistent with the present invention relate to using a service provided via a home network.

2. Description of the Related Art

An OpenCable Application Platform (OCAP) indicates a specification for a bi-directional television (TV) service or an application program. In order to define middleware allowed to be used in all cable TV broadcasting stations, Cable Television Laboratories, Inc. (CABLELABS), a cable TV technology research and development consortium, has developed a group of hardware and software specifications referred to as OCAP.

OCAP Home Networking Extension (OCAP-HNEXT) defines an application program interface (API), a content format, a data format and a protocol, which are necessary for an OCAP device connected to a home network so as to use services provided via the home network.

The OCAP-HNEXT defines various interfaces related to services so as to allow applications driven in OCAP middleware to use the services provided via the home network.

### SUMMARY OF THE INVENTION

Exemplary embodiments of the present invention provide a method and apparatus for allowing a predetermined device to use a service provided via a home network.

An exemplary embodiment of the present invention also provides a computer readable recording medium having recorded thereon a program for executing the method.

According to an aspect of the present invention, there is provided a method of using a service provided from a second device via a home network, the method, performed by a first device, including the operations of generating a plurality of objects for implementing different functions related to the service so as to allow an application driven in middleware of the first device to access the service; and using the service based on the plurality of objects, wherein identifiers of the plurality of objects are generated different from each other based on an identifier of the service.

The first device may be a digital cable receiver according to OpenCable Application Platform (OCAP) home networking extension.

The home network may be according to a Digital Living Network Alliance (DLNA) guide line, and the service may be a Content Directory Service (CDS).

The operation of generating the plurality of objects may include the operations of receiving a device description of the second device and a service description of the CDS via a control point of the home network; and generating a plurality of objects for implementing different functions of the CDS, based on the device description and the service description.

The operation of generating the plurality of objects for implementing the different functions of the CDS may include the operation of generating a ContentManagementNetModule object and a ContentServerNetModule object according to the OCAP home networking extension, based on the device description and the service description, and identifiers of the ContentManagementNetModule object and the ContentServerNetModule object may be generated different from each other based on an identifier of the CDS.

The different identifiers may be generated by adding different indexes to the identifier of the CDS.

The operation of generating the plurality of objects for implementing the different functions of the CDS may further include the operation of generating a third object for implementing functions of the CDS, which are implemented by the ContentManagementNetModule object and the ContentServerNetModule object, wherein the functions are of the CDS, and the operation of using the service may include the operation of using the CDS based on the third object.

An identifier of the third object may be the same as the identifier of the CDS.

According to another aspect of the present invention, there is provided an apparatus of a first device for using a service provided from a second device via a home network, the apparatus including a management unit for generating a plurality of objects for implementing different functions related to the service so as to allow an application driven in middleware of the first device to access the service; and a service driving unit for using the service based on the plurality of objects, wherein identifiers of the plurality of objects are generated different from each other based on an identifier of the service.

According to another aspect of the present invention, there is provided a method of using a service provided from a second device via a home network, the method, performed by a first device, including the operations of generating a plurality of objects for implementing different functions related to the service so as to allow an application driven in middleware of the first device to access the service; and using the service based on the plurality of objects, wherein the application refers to a list of the plurality of objects and retrieves an object so as to use the service, thereby using the service.

According to another aspect of the present invention, there is provided an apparatus of a first device for using a service provided from a second device via a home network, the apparatus including a management unit for generating a plurality of objects for implementing different functions related to the service so as to allow an application driven in middleware of the first device to access the service; and a service driving unit for using the service based on the plurality of objects, wherein the application refers to a list of the plurality of objects and retrieves an object so as to use the service, thereby using the service.

According to another aspect of the present invention, there is provided a computer readable recording medium having recorded thereon a program for executing the method.

### BRIEF DESCRIPTION OF THE DRAWINGS

The above and other features of the present invention will become more apparent by describing in detail exemplary embodiments thereof with reference to the attached drawings in which:

FIG. 1 is a diagram of a home network system according to an exemplary embodiment of the present invention;

FIG. 2 is a block diagram of a first device that uses a home network service, according to an exemplary embodiment of the present invention;

FIG. 3 is a block diagram for describing a method of using a home network service, as performed by a service driving unit, according to an exemplary embodiment of the present invention;

FIG. 4 is a block diagram for describing a method of generating a plurality of objects for implementing different functions of a Content Directory Service (CDS), according to an exemplary embodiment of the present invention;

FIG. 5 is a block diagram for describing a method of using a home network service, as performed by the service driving unit, according to another exemplary embodiment of the present invention;

FIG. 6 is a block diagram for describing a method of generating a third object for implementing a function of a CDS, according to another exemplary embodiment of the present invention; and

FIG. 7 is a flowchart of a method of using a home network service, according to another exemplary embodiment of the present invention.

### DETAILED DESCRIPTION OF THE INVENTION

Hereinafter, the present invention will be described in detail by explaining exemplary embodiments of the invention with reference to the attached drawings. Like reference numerals in the drawings denote like elements.

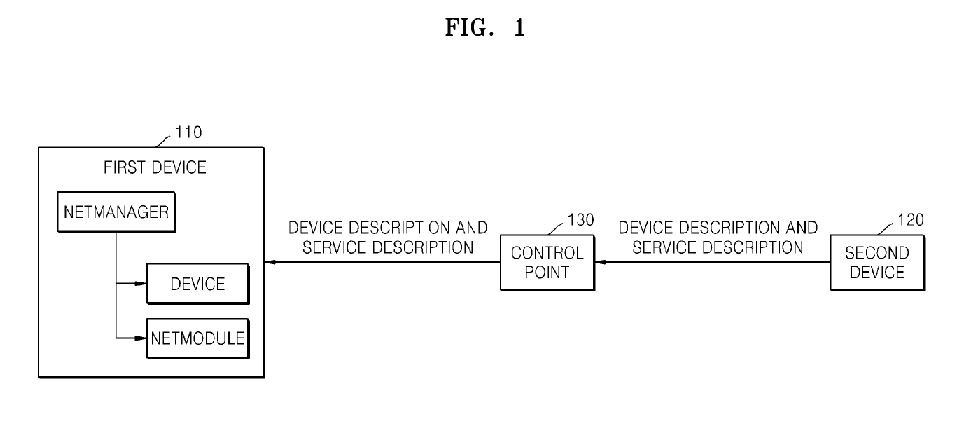

FIG. 1 is a diagram of a home network system according to an exemplary embodiment of the present invention.

FIG. 1 corresponds to a case in which a first device 110 uses a service provided from a second device 120 via a home network.

The first device 110 may be an OpenCable Application Platform (OCAP) home network device according to an OCAP home networking extension and the second device 120 may be a Universal Plug and Play (UPnP) device.

The second device 120 connected to the home network according to a Digital Living Network Alliance (DLNA) provides a device description and a service description to the first device 110 via a control point 130.

The first device 110 refers to the received device description and service description of the second device 120, thereby generating a plurality of objects for implementing different functions related to the service and which are according to middleware of the first device 110. For example, in the case where the first device 110 is the OCAP home network device, the middleware of the first device 110 may be JAVA middleware. In this case, applications driven in the middleware of the first device 110 use JAVA objects related to a service so as to use the service provided from the second device 120.

The OCAP home networking extension defines classes and interfaces, that is, home networking application program interfaces (APIs) to be used by the applications of the OCAP home network device. Thus, the first device 110 provides the APIs related to the service provided from the second device 120, wherein the APIs are from among the home networking APIs.

To be more specific, the first device 110 generates a “Device” object related to the second device 120 by using a “NetManager” class, according to the OCAP home networking extension, and generates a plurality of “NetModule” objects related to the service provided from the second device 120. The plurality of “NetModule” objects related to the service provided from the second device 120 are subordinated to the “Device” object of the second device 120 so as to indicate that the service is provided from the second device 120.

The “Device” object is generated based on the device description that is received via the control point 130 and that is of the second device 120, and the plurality of “NetModule” objects are generated based on the service description that is received from the control point 130 and that is of the second device 120.

FIG. 1 corresponds to the case in which the first device 110 receives the device description and the service description of the second device 120 via the control point 130. However, a method and apparatus for using a service according to one or more exemplary embodiments of the present invention are not limited thereto and thus the first device 110 may directly receive the device description and the service description from the second device 120.

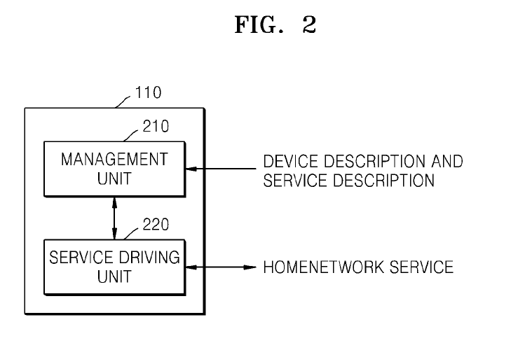

FIG. 2 is a block diagram of the first device 110 that uses a home network service, according to an exemplary embodiment of the present invention.

Referring to FIG. 2, the first device 110 according to the current exemplary embodiment includes a management unit 210 and a service driving unit 220. The management unit 210 and the service driving unit 220 according to the current exemplary embodiment may be implemented as hardware by using a central processing unit (CPU) and/or a memory which perform each of the functions to be described later.

Based on a device description and a service description of the second device 120, the management unit 210 generates a plurality of objects for implementing different functions related to a service of the second device 120. As described above in relation to FIG. 1, in the case where the first device 110 is an OCAP home network device, the plurality of objects, that is, a plurality of “NetModule” interfaces related to the service provided from the second device 120, may be generated.

When the second device 120 provides a Content Directory Service (CDS) via a home network, objects for implementing functions of the CDS may be two objects: a “ContentManagementNetModule” object and a “ContentServerNetModule” object, according to OCAP home networking extension. The “ContentManagementNetModule” object is an object for implementing a content management function such as copying, moving, deleting, and changing a name, which are related to a content directory or a file, and the “ContentServerNetModule” object is an object for implementing a content providing function such as fetching a content list or content information.

When the management unit 210 generates the plurality of objects for implementing the different functions related to the service provided from the second device 120, in order for applications driven in the first device 110 to use the service based on the plurality of objects, identifiers are required to distinguish between the plurality of objects. In order to use one of the content management function and the content providing function which are provided by the CDS, it is required to use one of the plurality of objects.

However, the OCAP home networking extension defines that identifiers of objects are generated based on an identifier of a service, thus, a plurality of objects for implementing different functions of the service have equal identifiers and thus the plurality of objects are not distinguishable. Hence, the first device 110 according to the current exemplary embodiment generates the identifiers of the objects based on the identifier of the service such that the identifiers are different from each other.

For example, when an identifier of the CDS is “urn:upnporg:serviceId:ContentDirectory.0001”, an identifier of the “ContentManagementNetModule” object may be “urn:upnporg:serviceId:ContentDirectory.0001-1”, wherein the “ContentManagementNetModule” object is generated by the management unit 210 and is for implementing the content management function of the CDS, and an identifier of the “ContentServerNetModule” object may be “urn:upnporg:serviceId:ContentDirectory.0001-2”. In this manner, by adding different indexes, that is, “-1” and “-2”, to the identifier of the service, the identifiers for the plurality of objects are generated.

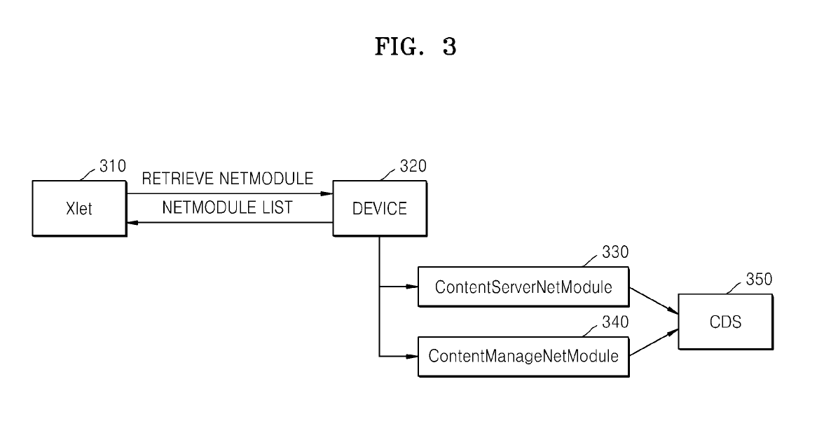

According to another exemplary embodiment of the present invention, although the plurality of objects for implementing the different functions related to the service have equal identifiers, if the service driving unit 220 can distinguish between the equal identifiers and use them, the management unit 210 may determine the equal identifiers of the plurality of objects according to the identifier of the service. A detailed description thereof will be described later with reference to FIG. 3.

Based on the plurality of objects generated by the management unit 210, the service driving unit 220 uses the service provided from the second device 120 via the home network. The service driving unit 220 executes a predetermined application requiring a home network service, and thus, uses the service provided from the second device 120. The predetermined application is an application driven in middleware of the first device 110, and uses the home network service, such as the CDS, based on the plurality of objects generated by the management unit 210.

FIG. 3 is a block diagram for describing a method of using a home network service, as performed by the service driving unit 220, according to an exemplary embodiment of the present invention.

Referring to FIG. 3, a predetermined application driven in middleware of the first device 110, that is, an Xlet 310 retrieves a plurality of objects for implementing different functions related to a CDS 350 so as to retrieve the CDS 350 provided from the second device 120. The Xlet 310 requests a “Device” interface 320 or a “NetModule” class (not shown) for predetermined “NetModule” interfaces related to the CDS 350.

In response to the request, the “Device” interface 320 or the “NetModule” class (not shown) transmits a list of objects, that is, a list of “NetModule” interfaces 330 and 340, to the Xlet 310. The list of objects includes the types of the “NetModule” interfaces and information about identifiers, which are generated by the management unit 210. Since the “NetModule” interfaces are not transmitted and the list of “NetModule” interfaces 330 and 340 are instead transmitted to the Xlet 310, thus, identifiers of the “NetModule” interfaces 330 and 340 may be set to be equal or different, as described above. According to the related art, when the Xlet 310 retrieves an object, if the Xlet 310 specifies and retrieves an identifier of the object, the object is directly transmitted to the Xlet 310. However, in this case, when identifiers of objects related to a service are equal, it is not possible to know which object will be transmitted to the Xlet 310. On the other hand, according to the current exemplary embodiment, when the list of objects is transmitted to the Xlet 310, the Xlet 310, that is, an application, directly selects the object required to use the service so that a problem due to object confusion may not occur.

In the case where identifiers of objects are generated by adding different indexes to a service identifier, the list may include information that is used in determination of the service identifier by referring to the identifiers of the objects.

For example, when an identifier of a “ContentManagementNetModule” object is “urn:upnporg:serviceId:ContentDirectory.0001-1” and an identifier of a “CententServerNetModule” object is “urn:upnporg:serviceId:ContentDirectory.0001-2”, a service identifier is “urn:upnporg:serviceId:ContentDirectory.0001”, thus, by including “44”, which is a character number of the service identifier, in the list, it is possible to determine the service identifier from the identifiers of the objects.

The Xlet 310 receives and refers to the list, thereby retrieving a required object from among the “NetModule” interfaces 330 and 340 so as to use the CDS 350. According to the types of the “NetModule” interfaces 330 and 340 included in the list, the Xlet 310 determines a currently required object and, based on a result of the determination, retrieves the object from among the “NetModule” interfaces 330 and 340.

OCAP home networking extension defines the types of the plurality of objects for implementing the different functions related to a service provided via the home network, wherein the types correspond to “Content_List”, “Content_Manager”, “Content_Recorder”, “Content_Renderer”, “Content_Server”, and the like. The type of the “ContentManagementNetModule” object is the “Content_Manager”, and the type of the “CententServerNetModule” object is the “Content_Server”. Thus, the Xlet 310 refers to the types of the “NetModule” interfaces 330 and 340 included in the list, thereby selecting and retrieving one of the “ContentManagementNetModule” object and the “CententServerNetModule” object.

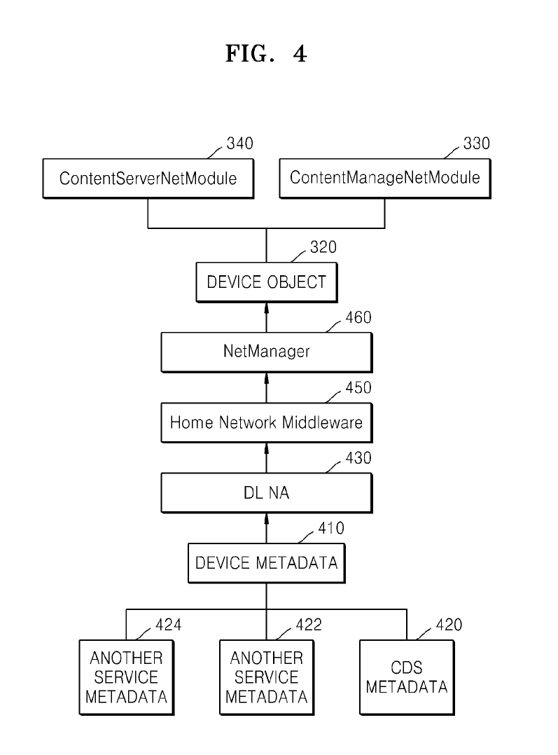

FIG. 4 is a block diagram for describing a method of generating a plurality of objects for implementing different functions of a CDS, according to an exemplary embodiment of the present invention.

Referring to FIG. 4, device metadata 410 included in a device description and a plurality of pieces of service metadata 420, 422 and 424 included in a service description are transmitted to the first device 110 via a DLNA network 430, that is, a home network. The first device 110 receives the device metadata 410 and the pieces of service metadata 420, 422 and 424 via home network middleware 450, and generates a “Device” object 320, a “ContentManagementNetModule” object 330 and a “CententServerNetModule” object 340 by using a “NetManager” class.

Referring back to FIG. 2, the management unit 210 according to the exemplary embodiment of FIG. 2 may generate a third object by combining a plurality of objects related to a service of the second device 120. For describing this by using the CDS, the management unit 210 may generate the third object for implementing all functions of the “ContentManagementNetModule” object 330 and the “CententServerNetModule” object 340.

Since one object for implementing all functions of the CDS is generated, an identifier of the third object may be set to be equal to an identifier of the service.

Based on the third object generated by the management unit 210, the service driving unit 220 (see FIG. 2) uses the service provided from the second device 120 via the home network.

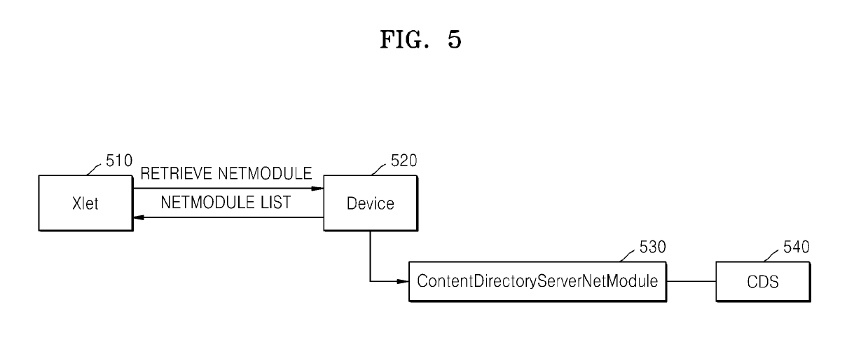

FIG. 5 is a block diagram for describing a method of using a home network service, as performed by the service driving unit 220, according to another exemplary embodiment of the present invention.

Referring to FIG. 5, a predetermined application driven in middleware of the first device 110, that is, an Xlet 510 retrieves an object for implementing functions of a CDS 540 so as to retrieve the CDS 540 provided from the second device 120. The Xlet 510 requests a “Device” interface 520 or a “NetModule” class (not shown) for a predetermined “NetModule” interface related to the CDS 540.

In response to the request, the “Device” interface 520 or the “NetModule” class (not shown) transmits information about a third object related to the CDS 540 to the Xlet 510. The information about the third object, that is, information about a type and an identifier of a “ContentDirectoryServiceNetModule” object, is transmitted to the Xlet 510. As described above, the identifier of the third object is the same as a service identifier of the CDS 540.

Unlike to the “ContentManagementNetModule” object and the “CententServerNetModule” object, which are described above, the type of the third object is not defined in OCAP home networking extension. Hence, the type of the third object has to be set as a third type that includes both a “Content_Manager” type and a “Content_Server” type. For this, a new object type is set by performing an XOR operation or an OR operation on the “Content_Manager” type and the “Content_Server” type. In other words, by performing the XOR operation or the OR operation on a binary string corresponding to the “Content_Manager” type and on a binary string corresponding to the “Content_Server” type, a binary string corresponding to the new object type is generated. The information about the type of the generated third and the identifier of the third object are transmitted to the Xlet 510.

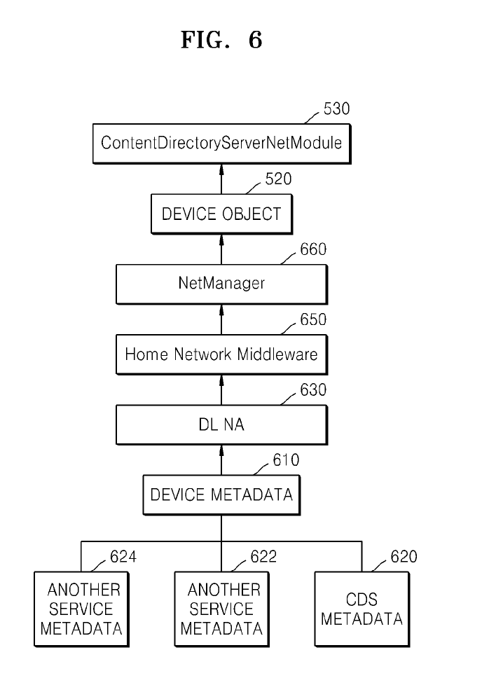

FIG. 6 is a block diagram for describing a method of generating a third object for implementing a function of a CDS, according to another exemplary embodiment of the present invention.

Referring to FIG. 6, device metadata 610 included in a device description and a plurality of pieces of service metadata 620, 622 and 624 included in a service description are transmitted to the first device 110 via a DLNA network 630, that is, a home network. The first device 110 receives the device metadata 610 and the pieces of service metadata 620, 622 and 624 via home network middleware 650, and generates a “Device” object 520 and a “ContentDirectoryServiceNetModule” object 530 by using a “NetManager” class 660.

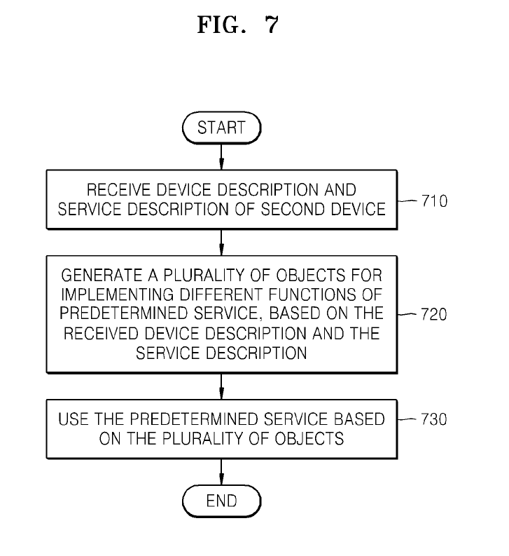

FIG. 7 is a flowchart of a method of using a home network service, according to another exemplary embodiment of the present invention.

Referring to FIG. 7, in operation 710, a first device receives a device description and a service description of a second device, where the first device and the second device are devices of the same home network. The first device and the second device are devices of a home network, wherein the first device may receive the device description and the service description of the second device via a control point, or may receive them directly from the second device. The first device may be an OCAP home network device according to OCAP home networking extension and the second device may be a UPnP device for providing a CDS via the home network.

In operation 720, based on the device description and the service description received in operation 710, the first device generates a plurality of objects for implementing different functions related to a service provided from the second device. That is, the plurality of objects necessary for a predetermined application to access the service are generated, wherein the predetermined application is driven in middleware of the first device. For describing this by using the CDS, a “ContentManagementNetModule” object and a “ContentServerNetModule” object are generated, wherein the “ContentManagementNetModule” object is for implementing a content management function of the CDS, such as copying, moving, deleting, and changing a name which are related to a content directory or a file, and the “ContentServerNetModule” object is for implementing a content providing function of the CDS, such as fetching a content list or content information. The plurality of objects are set to have different identifiers which are generated based on a service identifier.

The identifiers of the “ContentManagementNetModule” object and the “ContentServerNetModule” object may be set to be equal to the service identifier. In this case, the application accessing the home network refers to a list of the “ContentManagementNetModule” object and the “ContentServerNetModule” object, thereby accessing the service by using the required object. Since the list includes the plurality of objects for implementing the different functions of the home network service, although the identifiers of the plurality of objects are equal, the application may retrieve an appropriate object according to a service to be used and may use the service.

A third object for implementing all functions of a service provided from the second device may be generated. For example, the third object, that is, a “ContentDirectoryServiceNetModule” object for implementing the functions of the CDS, may be generated, wherein the functions of the CDS are implemented by the “ContentManagementNetModule” object and the “ContentServerNetModule” object. At this time, an identifier of the third object is the same as the service identifier, and with respect to an object type, a third object type is generated by combining object types of the “ContentManagementNetModule” object and the “ContentServerNetModule” object.

In operation 730, based on the plurality of objects generated in operation 720, the first device uses the service that is provided from the second device via the home network. In the case where the third object is generated by combining the plurality of objects in operation 720, the first device uses the service based on the generated third object.

The exemplary embodiments of the present invention can be written as computer programs and can be implemented in general-use digital computers that execute the programs using a computer readable recording medium. In addition, a data structure used in the exemplary embodiments of the present invention can be written in a computer readable recording medium through various means. Examples of the computer readable recording medium include read-only memory (ROM), random-access memory (RAM), CD-ROMs, magnetic tapes, floppy disks, optical data storage devices, etc.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of using a service provided from a second device via a home network, the method being performed by a first device, the method comprising:
generating a plurality of objects for implementing different functions related to the service, to allow a middleware application of the first device to access the service; and
using the service based on the plurality of objects,
wherein identifiers of the plurality of objects are generated different from each other based on an identifier of the service.

2. The method of claim 1, wherein the first device is a digital cable receiver according to an OpenCable Application Platform (OCAP) home networking extension.

3. The method of claim 2, wherein the home network is according to a Digital Living Network Alliance (DLNA) guide line, and
wherein the service is a Content Directory Service (CDS).

4. The method of claim 3, wherein the generating of the plurality of objects comprises:
receiving a device description of the second device and a service description of the CDS via a control point of the home network; and
generating the plurality of objects for implementing different functions of the CDS, based on the device description and the service description.

5. The method of claim 4, wherein the generating of the plurality of objects for implementing the different functions of the CDS comprises generating a ContentManagementNetModule object and a ContentServerNetModule object according to the OCAP home networking extension, based on the device description and the service description, and
wherein an identifier of the ContentManagementNetModule object and an identifier of the ContentServerNetModule object are generated different from each other based on an identifier of the CDS.

6. The method of claim 5, wherein the identifiers of the ContentManagementNetModule object and the ContentServerNetModule object are generated by adding different indexes to the identifier of the CDS.

7. The method of claim 5, wherein the generating of the plurality of objects for implementing the different functions of the CDS further comprises generating a third object for implementing functions of the CDS, which are implemented by the ContentManagementNetModule object and the ContentServerNetModule object, and
wherein the using of the service comprises using the CDS based on the third object.

8. The method of claim 7, wherein an identifier of the third object is the same as the identifier of the CDS.

9. An apparatus of a first device for using a service provided from a second device via a home network, the apparatus comprising:
a management unit which generates a plurality of objects for implementing different functions related to the service, to allow a middleware application of the first device to access the service; and
a service driving unit which uses the service based on the plurality of objects,
wherein identifiers of the plurality of objects are generated different from each other based on an identifier of the service.

10. The apparatus of claim 9, wherein the first device is a digital cable receiver according to an OpenCable Application Platform (OCAP) home networking extension.

11. The apparatus of claim 10, wherein the home network is according to a Digital Living Network Alliance (DLNA) guide line, and
wherein the service is a Content Directory Service (CDS).

12. The apparatus of claim 11, wherein the management unit receives a device description of the second device and a service description of the CDS via a control point of the home network, and generates the plurality of objects for implementing different functions of the CDS, based on the device description and the service description.

13. The apparatus of claim 12, wherein the object generating unit generates a ContentManagementNetModule object and a ContentServerNetModule object according to the OCAP home networking extension, based on the device description and the service description, and
wherein an identifier of the ContentManagementNetModule object and an identifier of the ContentServerNetModule object are generated different from each other based on an identifier of the CDS.

14. The apparatus of claim 13, wherein the identifiers of the ContentManagementNetModule object and the ContentServerNetModule object are generated by adding different indexes to the identifier of the CDS.

15. The apparatus of claim 13, wherein the object generating unit generates a third object for implementing functions of the CDS, which are implemented by the ContentManagementNetModule object and the ContentServerNetModule object, and
wherein the service driving unit uses the CDS based on the third object.

16. The apparatus of claim 15, wherein an identifier of the third object is the same as the identifier of the CDS.

17. A computer readable recording medium having recorded thereon a program for executing the method of claim 1.

18. A method of using a service provided from a second device via a home network, the method being performed by a first device, the method comprising:
generating a plurality of objects for implementing different functions related to the service, to allow a middleware application of the first device to access the service; and
using the service based on the plurality of objects,
wherein the middleware application refers to a list of the plurality of objects and retrieves one of the plurality of objects, to use the service.

19. The method of claim 18, wherein the list comprises information about all objects having identifiers equal to an identifier of the service.

20. The method of claim 19, wherein the service is a Content Directory Service (CDS) provided from the home network according to a Digital Living Network Alliance (DLNA) guide line, and
wherein the plurality of objects comprise a ContentManagementNetModule object and a ContentServerNetModule object according to an OpenCable Application Platform (OCAP) home networking extension, based on a device description and a service description received via a control point of the home network.

21. An apparatus of a first device for using a service provided from a second device via a home network, the apparatus comprising:
a management unit which generates a plurality of objects for implementing different functions related to the service, to allow a middleware application of the first device to access the service; and
a service driving unit which uses the service based on the plurality of objects,
wherein the application refers to a list of the plurality of objects and retrieves one of the plurality of objects, to use the service.

22. The apparatus of claim 21, wherein the list comprises information about all objects having identifiers equal to an identifier of the service.

23. The apparatus of claim 22, wherein the service is a Content Directory Service (CDS) provided from the home network according to a Digital Living Network Alliance (DLNA) guide line, and
wherein the plurality of objects comprise a ContentManagementNetModule object and a ContentServerNetModule object according to an OpenCable Application Platform (OCAP) home networking extension, based on a device description and a service description received via a control point of the home network.

24. A computer readable recording medium having recorded thereon a program for executing the method of claim 18.
